(19) United States
(12) Patent Application Publication
(10) Pub. No.: US 2012/0170976 A1
(43) Pub. Date: Jul. 5, 2012

(54) Working Head of Pendulum Tool and Converter

(76) Inventor: Lvqian Cai, Yongkang (CN)

(21) Appl. No.: 13/381,913

(22) PCT Filed: Jul. 1, 2010
(86) PCT No.: PCT/CN2010/074887

§ 371 Date: Mar. 27, 2012

(30) Foreign Application Priority Data
Jul. 1, 2009 (CN) 200920162171.9

(51) Int. Cl. F16D 1/06

(52) U.S. Cl. 403/359.1; 403/361

(57) ABSTRACT

A working head connected to an output shaft of a pendulum tool and a converter used when the working head isn't fitted in with the pendulum tool are disclosed. A connecting segment provided on a installation interface of both the working head and the converter is used to communicate a center hole with an outer hollow-out area. Thus, the amount of the hollow areas isolated from the center hole on the installation interface of the working head and the converter are reduced, so the integrity and structure strength of manufacturing the working head is better, and when the hollow areas isn't fitted in with the limit posts or the limit posts aren't provided, the working head or the converter and the pendulum tool can also connect with each other by the connecting segment fitted in with the limit blocks on the pendulum tool.

### FIELD OF THE INVENTION

The invention relates to a kind of working head of pendulum tool connected with an output shaft and a converter used in case that the working head doesn't match with the pendulum tool.

### BACKGROUND OF THE INVENTION

The installation interface of the working head of pendulum tool or the converter can be fixedly connected with the output shaft of the pendulum tool in the following three methods:

The first method is represented by the pendulum tools such as MSx 636 II and MSe 636 II produced by FEIN POWER TOOLS INC in Germany. The working head (the saw blade, for example) or the converter and the output shaft of the pendulum tool is fixedly connected by frictional resistance (fastener), with the designing of a center bore (a circular hole) in the installation interface of the working head or the converting interface of converter which facilitates the connection between the head or converter and the output shaft. This type of working head or converter is characterized by the installation interface that only has a center bore without any hollow or concaves to stop spacing or control location; the center bore can be a circular hole or a regular polygon.

The second method is represented by the pendulum tools called MULTIMASTER (ZL 01143111. 3 for example), such as set START and set SELECT produced by FEIN POWER TOOLS INC in Germany. This type of tools provides a tool holder used for fixing the tool in the driving shaft. The tool holder, set on the tool or the driving shaft, is equipped with a connecting hole which functions with a raising connecting segment shaped accordingly on the other element, making a joint closure. The joint can pass the torque between the driving shaft and the tool. Besides, the rotationally symmetric connecting hole has at least three outward rounding-off edges, every two of which are connected with each other on the curving segment along the central line. The working head (saw blade, for example) or the converter and the output shaft of the pendulum tool is fixed by limited blocks with the designing of a center bore (a circular hole) and the relevant connecting segment in the installation interface of the working head or converting interface of the converter which connect with stop bocks on the output shaft of the pendulum tool. This type of working head or converter is characterized by the designing of a center bore in the installation interface and the correspondent connecting or converting segment, both of which are integrated.

The third method is represented by the pendulum tools such as PMF 180E (application no. 200580035853. 3) produced by BOSCH CORP. in Germany. This type of tool is equipped with a centering element and at least one conformal closure, both of which are used to fasten the axially-opened tools to the vibrantly driving shaft in the hand-held machine tool. The centering element is designed for the centering of tools relative to the driving shaft, while the form-locking element is used to locate the rotating position of tools relative to the driving shaft. The working head (the saw blade, for example) can be fixedly connected with the output shaft of the pendulum tool by limited blocks with the designing of a center bore (or a circular hole) in the installation interface and the hollowing-out areas around the center bore, enabling the tool to stop or work in accordance with the limited blocks on the output shaft which are evenly distributed axially in peripheral circles. The working head of this type is characteristic of the designing of a center bore (or a circular hole) in the installation interface and the hollowing-out areas around the center bore, both of which are independent, so it is the same with the converter.

The working head or converter which the connecting methods are the second and the third type can be applied to pendulum tool of the first type, but not in case of the second to the third.

Neither can the working head or convertor which the connecting method is the third be applied to the pendulum tools of the second type. Therefore, different interfaces may arouse inconvenience to the users, especially in the third situation that the center bore (or the circular hole) of the installation interface in the third type of working head is independent from the hollowing-out areas around the center bore, so it is with the interface of the converter. The manufacturing of working head or the relative parts on the mould is done separately, with low structural strength and machining accuracy moulds in poor quality, the machining accuracy of the interface of working head or the converter not being guaranteed, the manufacturing cost rising and the universality declining.

### SUMMARY OF THE INVENTION

The aim of the invention is to improve the existing working head of pendulum tools and to provide a working head featured by better universality with the module of good integrity and structure strength. All the connecting segments in the invention are joined together with the center bore, though they can be independent.

The converter in the invention is featured by better universality with high-quality moulds which have good integrity and structure strength. All the converting segments in the invention are joined together with the center bore, though they can be independent.

The working head in the invention functions can be fulfilled in the following technical schemes:

A working head of pendulum tools, its output shaft of the pendulum tool vibrates and drives around the axis and has toggle for fixing the working head. The head is equipped with an installation interface used for connecting with the fixing element on the tool, as well as a functional terminal connecting with the interface which has a center bore and twelve hollowing-out areas around the center bore. The twelve limited blocks on the output shaft accordingly can be placed in the areas respectively, evenly distributed axially in peripheral circles. Meanwhile, at least one connecting segment pointing to the center bore in the installation interface of working head shall be disposed, enabling the center bore to connect with at least one hollowing-out areas. The connecting segment is a groove or opening on the installation interface, the hollowing-out areas between which and the center bore can be the location of the limited blocks on the output shaft. In this way, the number of hollowing-out areas between the center bore and the interface decreases, making high-quality moulds with good integrity and structure strength. Moreover, in the case that the hollowing-out areas doesn't match with the limited stop, the hollowing-out plane along the connecting segments can still match the limited blocks on the pendulum tools, fulfilling the connection of the working head and the tool.

The invention has the advantages that the manufacturing cost is low, the universality better, namely, the working head can be applied to the pendulum tools of the third type as well as the first and second type.

In the invention, the functional terminal of the working head can be sawing, grinding, cutting or polishing tools, etc., so it is with the working head. For instance, for the working head being sawing instruments, it can be the one with corresponding jags to handle wood, plastics, metal and so forth; also, the working head can be grinding tools with hard materials of certain grits such as hard alloy or diamond particles to deal with stuff made of stone or concrete; the head may be cutting tools with certain shapes and functions, etc.

In the invention, at least four segments evenly distributed and connected with center bores shall be set on the installation interface of the working head mentioned above. Connecting with the segments, the center bore s form a hollowing-out plane in which at least four limited blocks can be placed along the output shaft of the pendulum tool. The installation interface of this type can be installed in the output shaft of the pendulum tools represented by set START and set SELECT manufactured by FEIN POWER TOOLS INC in Germany. On the output shaft of this pendulum tool, four limited blocks are connected with the corresponding segments. The working head (the sawing blade, for example) is fixedly connected with the output shaft by limited blocks.

In the invention, at least one segment shall be disposed on the installation interface of the working head pointing to the center bore connecting with two or three adjacent hollowing-out areas around the center bore. In this way, the number of separate hollowing-out areas outside the center bore will decrease, improving the integral quality and structural strength of the moulds which manufacture the working head.

The invention hereby is provided with four evenly distributed connecting segments on the installation interface of the working head which link the center bore to four or eight or twelve hollowing-out areas around the center bore, drastically decreasing the number of hollowing-out areas around the center bore, or even leaving no independent hollowing-out areas around the center bore.

On the installation interface of the working head in the invention herein, eight evenly distributed connecting segments are disposed, among four of which, each connects with one adjacent hollowing-out areas and among the rest every two segments connect with two adjacent hollowing-out areas. These two connecting methods interlace with each other. Besides, eight evenly distributed limited blocks on the output shaft can be placed in the hollowing-out plane formed by the center bore and the connecting segments leaving no independent hollowing-out areas around the center bore. All guarantees better integrity and structural strength of the moulds used to manufacture the working head. This type of working head can be assembled to the products such as set START and set SELECT produced by FEIN POWER TOOLS INC in Germany from eight different perspectives as eight evenly distributed connecting segments are disposed on the installation interface of the working head linking to the center bore. The output shaft of these products is equipped with four limited blocks relative to the shape of segments, which is the optimization of the scheme.

On the installation interface of the working head in the invention herein, are eight evenly distributed connecting segments, among four of which each connects with the center bore instead of any adjacent hollowing-out areas and among the rest every two segments connect with two adjacent hollowing-out areas. These two connecting methods interlace with each other. Besides, eight evenly distributed limited blocks on the output shaft can be placed in the hollowing-out plane formed by the center bore and the connecting segments leaving only four independent hollowing-out areas outside the center bore. All guarantees better integrity and structural strength of the moulds used to manufacture the working head. This type of working head can be assembled to the products such as set START and set SELECT produced by FEIN POWER TOOLS INC. in Germany from eight different perspectives as eight evenly distributed connecting segments are disposed on the installation interface of the working head linking to the center bore. The output shaft of this type of products is equipped with four limited blocks relative to the shape of segments, which is also the optimization of the scheme.

In the scheme, the center bore of the installation interface on the working head can be circular, regular polygon, eight-star shaped, twelve-star shaped, etc.; the shape of the connecting segments of the interface is adapted to the cross section of the limited blocks on the output shaft of the pendulum tool. Limited blocks can be placed in the hollowing-out plane formed by the center bore and the connecting segments, namely, the hollowing plane can hold the section of these limited blocks. The connecting segments can be designed with or without the function as limiting with the limited blocks; in the latter case the space between the hollowing plane and the limited blocks shall be larger. The shape of the hollowing-out areas around the center bore is adapted to the shape of the limited column on the output shaft of the pendulum tool. Limited columns can be placed in the hollowing-out areas around the center bore, namely, the hollowing-out areas can hold the section of the limited columns. The connecting segments can be designed with or without the function as limiting with the limited columns; in the latter case the space between the hollowing-out areas and the limited columns shall be larger. The cross section of the limited column can be circular, elliptical, long circular or rectangular, so can the hollowing-out areas on the installation interface of the working head, accordingly.

Secondly, the converter in the invention herein can be fulfilled in the following technical schemes:

The converter herein is used to fasten the working head which has unmatched interface with the limited block or the limited post, to the output shaft of the pendulum tool. One side of the converter is provided with a converting interface linked to the output shaft of the pendulum tool on which exists a center bore for conversion and twelve hollowing-out areas around the center bore, so as to fix the working head on the other side of the converter. The converter is characterized in that at least one converting segment exists on the groove or opening, communicated with the center bore on the interface of the converter, leading to the communication between the center bore and at least one of the hollowing-out areas; besides, a limited block on the output shaft of the pendulum tool can be put in the hollowing plane formed by the center bore and the converting segments, thus reducing the number of independent hollowing-out areas between the center bore and the converting segments. The moulds used for the production of the converter has better integrity and higher structure strength. Properly, this type of converters can be disposed on the output shaft in the pendulum tools of the second type, on which is a corresponding limited block for the converting segments.

The invention has the advantages that the manufacturing cost is low; the universality better, namely, the converter hereof can be applied to pendulum tools of the third type as well as the first and the second type.

On the installation interface of the converter in this invention, at least one converting segment is communicated to the center bore, as well as to two or three adjacent hollowing-out areas for conversion, so as to reduce the number of independent hollowing-out areas around the center bore and to improve the integrity and structural strength of the moulds used for the manufacturing of the convertor of this type.

On the interface of the converter in this invention, four evenly distributed converting segments are disposed to communicate to the center bore, enabling the center bore to communicate with four, eight or twelve hollowing-out areas around the center bore, therefore reducing the number of independent hollowing-out areas around, or even leaving no separate hollowing-out areas around the center bore.

On the interface of the converter in the invention herein, eight evenly distributed converting segments which are linked with center bore are disposed, among four of which each connects with one adjacent hollowing-out areas and among the rest every two segments connect with two adjacent hollowing-out areas. These two connecting methods interlace with each other. Besides, eight evenly distributed limited blocks on the output shaft can be placed in the hollowing-out plane formed by the center bore and the converting segments leaving no independent hollowing-out areas around the center bore. All guarantees better integrity and structural strength of the moulds used to manufacture the converter. This type of converter can be disposed on the products such as set START and set SELECT produced by FEIN POWER TOOLS INC in Germany from eight different perspectives as eight evenly distributed converting segments which are linked with the center bore are disposed on the interface of the converter linked to the center bore. The output shaft of these products is equipped with four limited blocks relative to the shape of converting segments, which is the optimization of the scheme.

On the interface of the convertor in the invention herein, eight evenly distributed connecting segments are disposed, among four of which each connects with the center bore instead of any hollowing-out areas and among the rest every two segments connect with two adjacent hollowing-out areas. These two connecting methods interlace with each other. Besides, eight evenly distributed limited blocks on the output shaft can be placed in the hollowing-out plane formed by the center bore and the connecting segments leaving only four independent hollowing-out areas around the center bore. All guarantees better integrity and structural strength of the moulds used to manufacture the working head. This type of converter can be disposed on the products such as set START and set SELECT produced by FEIN POWER TOOLS INC in Germany from eight different perspectives as eight evenly distributed converting segments which are linked with the center bore are disposed on the interface of the converter linked to the center bore. The output shaft of these products is equipped with four limited blocks relative to the shape of segments, which is also the optimization of the scheme.

In the scheme mentioned above, the center bore of the interface on the converter can be circular, regular polygon, eight-star shaped, twelve-star shaped, etc.; the shape of converting segments of the interface is adapted to the cross section of the limited blocks on the output shaft of the pendulum tool. Limited blocks can be placed in the hollowing-out plane formed by the center bore and the converting segments, namely, the hollowing plane can hold the section of these limited blocks. The converting segments can be designed with or without the function as limiting with the limited blocks; in the latter case the space between the hollowing plane and the limited blocks shall be larger. The shape of the hollowing-out areas around the center bore is adapted to the shape of the limited column on the output shaft of the pendulum tool. Limited columns can be placed in the hollowing-out plane around the center bore, namely, the hollowing-out areas can hold the section of the limited columns. The converting segments can be designed with or without the function as limiting with the limited columns; in the latter case the space between the hollowing plane and the limited columns shall be larger. The cross section of the limited column can be circular, elliptical, long circular or rectangular, so can the hollowing-out areas on the interface of the converter, accordingly.

### BRIEF DESCRIPTION OF THE DRAWINGS

FIG. 1 is a front view of the working head in accordance with the first embodiment of the invention, in which the functional terminal is shown as the sawing instrument with jags.

FIG. 2 is a cross sectional view of the working head disposed on the pendulum tool shown in FIG. 1, embodying that the output shaft of the pendulum tool of the working head vibrates and drives around the axis and has the toggle to fix the working head.

FIG. 3 is the second embodiment of the working head of the invention.

FIG. 4 is the third embodiment of the working head of the invention.

FIG. 5 is the fourth embodiment of the working head of the invention.

FIG. 6 is the fifth embodiment of the working head of the invention.

FIG. 7 is the sixth embodiment of the working head of the invention.

FIG. 8 is the seventh embodiment of the working head of the invention.

FIG. 9 is the eighth embodiment of the working head of the invention.

FIG. 10 is the ninth embodiment of the working head of the invention.

FIG. 11 is a front view of the converter in accordance with the first embodiment of the invention.

FIG. 12 is a cross sectional view of the converter disposed on the pendulum tool shown in FIG. 11, embodying how the working head, with unmatched interfaces with the shape of the limited block or limited post, is fixed on the output shaft and the output shaft of the pendulum tool vibrates and drives around the axis and has the toggle to fix the working head.

FIG. 13 is a back view of the converter shown in FIG. 11, in which the bulged connecting segments are shown as regular hexagons.

FIG. 14 is a front view of the converter in accordance with the second embodiment of the converter.

FIG. 16 is a front view of the converter in accordance with the third embodiment of the converter.

FIG. 17 is a front view of the converter in accordance with the fourth embodiment of the converter.

FIG. 18 is a front view of the converter in accordance with the fifth embodiment of the converter.

FIG. 19 is a front view of the converter in accordance with the sixth embodiment of the converter.

FIG. 20 is a front view of the converter in accordance with the seventh embodiment of the converter.

FIG. 21 is a back view of the converter in accordance with the optimized embodiment of the converter, showing the bulged geared segments.

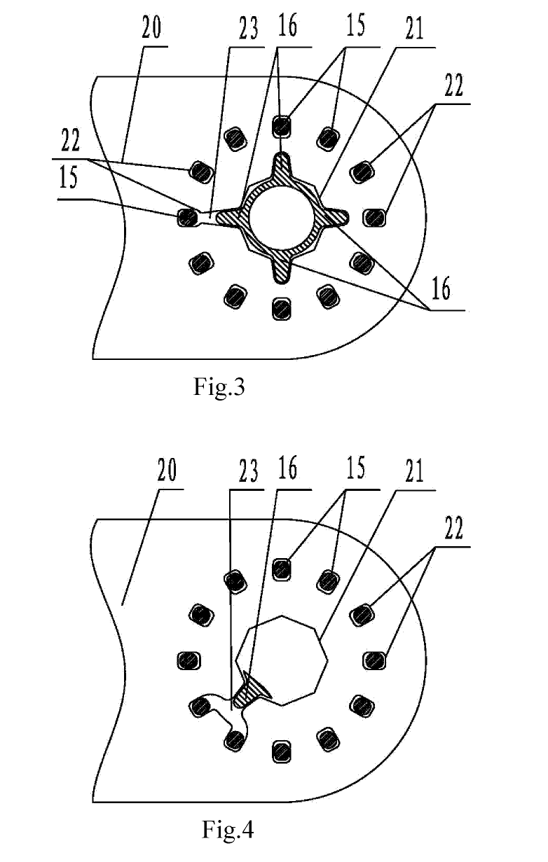

FIGS. 3˜10 do not show the functional terminal.

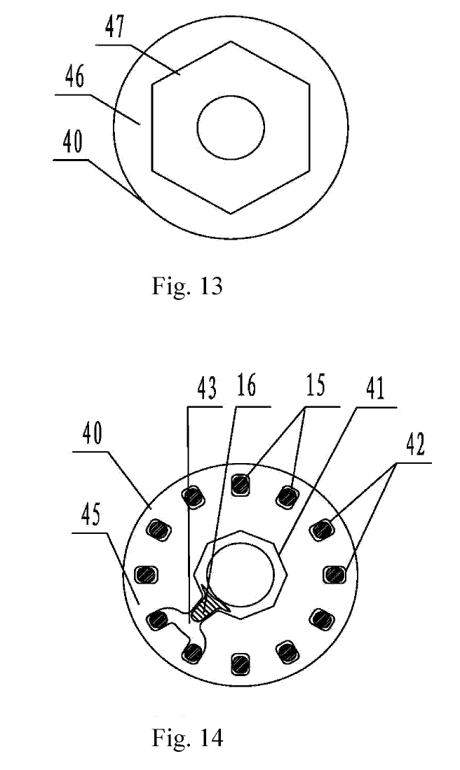

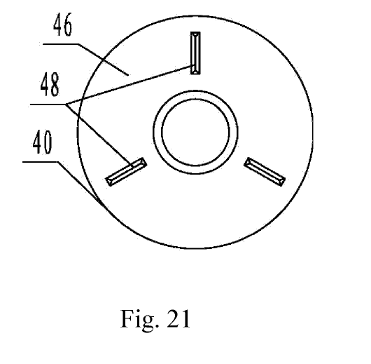

For the sake of convenience, the limited blocks and limited columns on the output shaft are all shown in all the figures (except FIG. 13 and FIG. 21) to exclude the extra perspective views, as the limited blocks and limited columns on the output shaft usually, are not concurrently assembled on the same pendulum tool. In all the figures, limited columns are shown as rectangles with a fillet-edged section and the center bores as regular octagons.

### DETAIL DESCRIPTION OF THE INVENTION

To enable a further description of the technical schemes of the invention herein, refer to the model embodiment and the accompanying drawings below:

As shown in FIG. 2, the output shaft 12 of the working head 10 runs at a rate of 5,000 to 25,000 per minute by a rotary angle of 0.6˜7° around the axis 14.

The output shaft 12 is provided with the toggle to fix the working head 20 which is shown in FIG. 2 as a cross section of the installation interface. For instance, the working head 20 can be fixed on the output shaft 12 through the installation interface with the assistance of a tapped blind hole and a screw 30.

Self-evidently, the working head 20 can be connected with the output shaft 12 through toggle of other shapes such as hex sockets and other toggles.

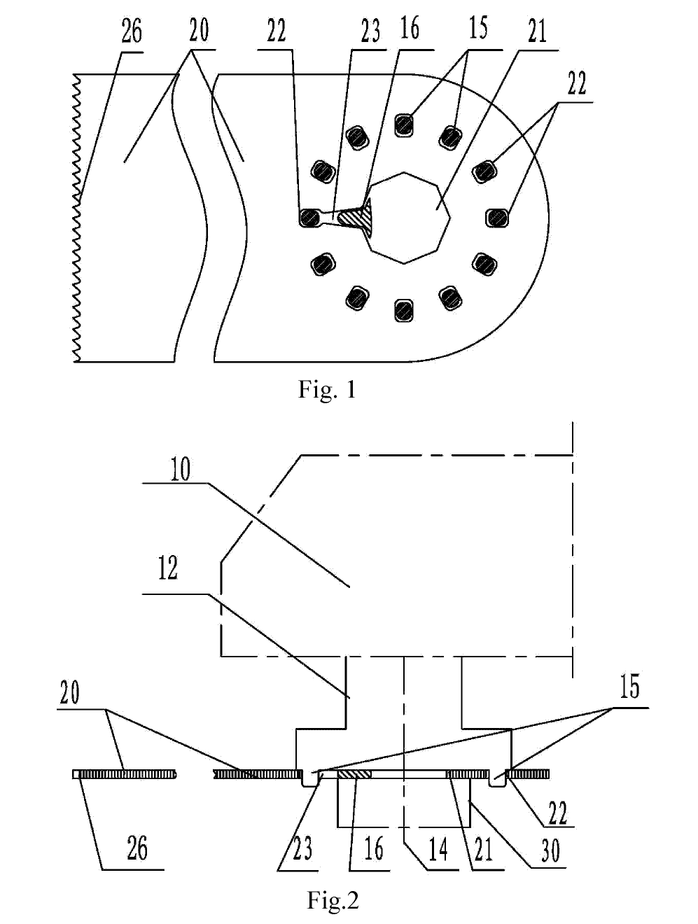

As shown in FIG. 1, the working head 20 of the pendulum tool is designed with a fixed installation interface to connect with the toggle of the pendulum tool. The working head 20 also has a functional terminal 26 connecting with the installation interface, on which exists a center bore 21 and twelve hollowing-out areas 22 along the outer side of the center bore 21. The twelve hollowing-out areas 22 can be inserted with the twelve corresponding circumferential limited columns evenly distributed along the axis of the output shaft of the pendulum tool. The installation interface has a connecting segment 23 connected with the center bore 21 to connect the center bore 21 with one of the twelve hollowing-out areas 22. The hollowing-out plane between the center bore 21 and the connecting segment 23 can be inserted with a limited block 16 on the output shaft of the pendulum tool. This type of working head can be assembled in twelve different angles onto the corresponding position of evenly distributed limited columns on the output shaft of the pendulum tool. In the same way, it can be assembled in twelve different angles onto the following pendulum tools: pendulum tool with one, two, three, four, or six evenly distributed limited columns on the corresponding position of its output shaft, including the ones that adopt the same way of even distribution of twelve columns but several of the positions are without limited columns; a pendulum tool with one limited block on the corresponding position of the output shaft in a defined angle; a pendulum tool without any limit column or limited block on the corresponding position of the output shaft in any angle.

In FIG. 3, the four evenly distributed connecting segment 23 on the installation interface of the working head 20 are connected with the center bore 21. The hollowing-out plane between center bore 21 and connecting segment 23 can be inserted with four evenly distributed limited block 16 on the output shaft of the pendulum tool. This type of working head can be assembled in four defined angles onto the corresponding position of the output shaft on the pendulum tools, which have one, two, four limited blocks or have positions for four evenly distributed limited blocks while positions of a plurality of limited blocks have not been set.

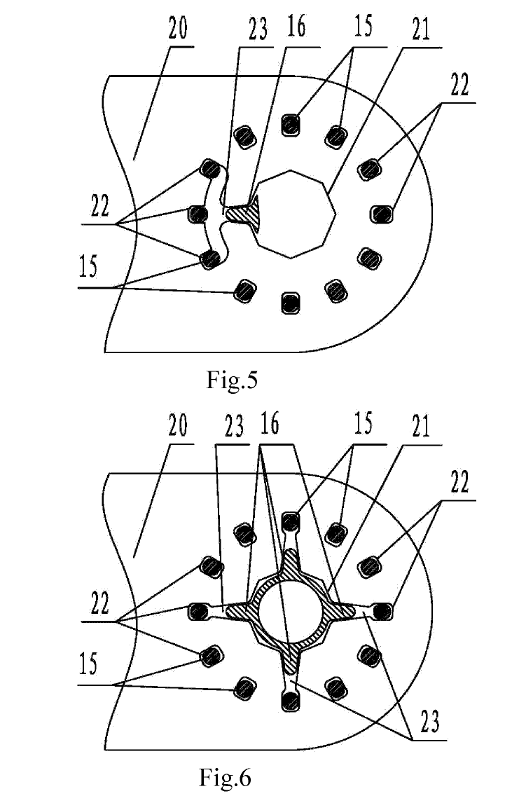

In FIGS. 4 and 5, the connecting segment 23 connected with the center bore 21 on installation interface of working head 20 is separately used to connect three or four adjacent hollowing-out areas 22.

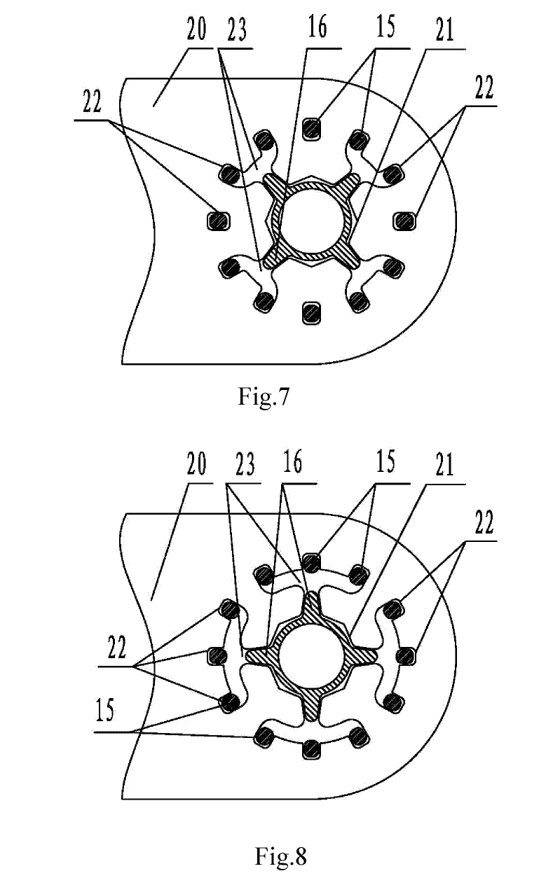

FIGS. 6, 7, 8, 9 and 10 show the working head with further improved embodiment. In FIGS. 6, 7 and 8, the four evenly distributed connecting segment 23 on the installation interface of the working head 20 are connected with the center bore 21 to connect the center bore 21 with four, eight or twelve hollowing-out areas 22. The hollowing-out plane between center bore 21 and connecting segment 23 can be inserted with four evenly distributed limited block 15 on the output shaft of the pendulum tool. The quantity of isolated hollowing-out areas outside the center bore are largely decreased, even eliminated, improving the integral quality and structural strength of the moulds which manufacture the working head.

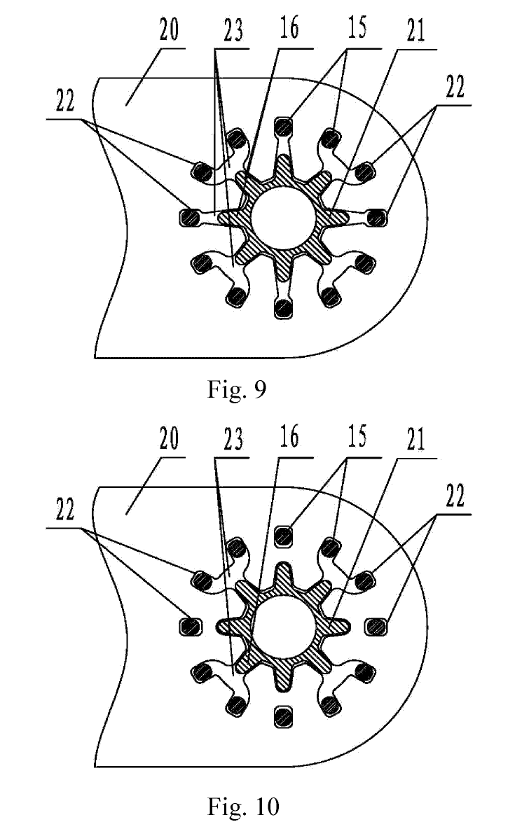

In FIGS. 9 and 10, eight evenly distributed connecting segments 23 connected with the center bore 21 on the installation interface of the working head 20 are disposed. It can be chosen to connect four of the connecting segments 23 with one corresponding neighboring hollow area 22; while the other four connecting segments 23 are connected with the corresponding two neighboring hollow areas 22. These two ways of connection are adopted alternatively. The hollowing-out plane between center bore 21 and connecting segment 23 can be inserted with eight evenly distributed limited blocks 16 on the output shaft of the insertable pendulum tool. As shown in the figures, the module for manufacturing the working head is of relatively good integrity and structural strength, so as to produce relatively high structural strength of the working head. This type of working head can be assembled in eight defined angles onto the corresponding position of the output shaft on the pendulum tools, which have one, two, four or eight limited blocks or have positions for eight evenly distributed limited blocks with position of a plurality of the limited block not being set. Without doubt, this type of working head can be assembled in twelve defined angles onto the corresponding position of the output shaft on the pendulum tool with twelve evenly distributed limited columns. This type of working head can be assembled in any angle onto output shaft of the pendulum tool without limited columns or limited blocks. Working head can be assembled in various angles onto pendulum tools for an easy operation and less work intensity.

The center bore of the installation interface on the working head can be circular, regular polygon, eight-star shaped, twelve-star shaped, etc.; among which circle and regular polygon are first priorities. The shape of converting segments of the interface is adapted to the cross section of the limited blocks on the output shaft of the pendulum tool. The hollowing-out plane between the center bore and the connecting segment can be inserted with limited block of the output shaft of the pendulum tool, i.e. the hollowing-out plane between the center bore and the connecting segment can contain the cross section of the stop block. The connecting segment can be used as a limit black together with stop block or not be used for limit function. The hollow area on outer side of the center bore on the installation interface of working head shall be able to couple with the limit column on output shaft of the pendulum tool, which can be inserted into the hollow area. Namely, the hollow area shall be large enough to hold the cross section of the limited column. The connecting segment can function as position limit together with limited column or not used for that function. The cross section of the limited column can be circular, elliptical, long circular or rectangular, so can the hollowing-out areas on the installation interface of the working head, accordingly, among which rectangle is the first priority, so as to couple with the section shape of the limited column.

Self-evidently, the shape of installation interface is flexible on the premise of the embodiment mentioned above. The professional technicians can decide the hollowing design on a plurality of parts of installation interface, which will not be repeated herein.

In a word, this working head of the invention can be adopted in any angle in various pendulum tools for an easy operation and a deduction of work intensity. Meanwhile, the module for manufacturing the working head is of relatively good integrity and structural strength, and the structural strength of working head is relatively high, which makes the product of low cost and high quality.

FIG. 12 shows the cross section of the installation interface of the converter 40. On the cross section of the converter 40 that is assembled on the pendulum tool, of which, it embodies the way to connect the installation interface with mismatching working head 20a on the different shaped limited column 15 or limited block 16 of the output shaft of pendulum tool through by fixing the converter 40 onto the output shaft 12, in this way, the output shaft 12 of pendulum tool is driven around its axis with toggle of fixed working head 20a and converter 40. The fixed part of it can be a screwed blind hole and a bolt 30. The toggles fix the working head 20a on the output shaft 12 through the converter 40.

Self-evidently, the working head 20a can be fixed and connected with converter 40 and output shaft 12 in other ways. For example, fasteners such as hex socket can be adopted.

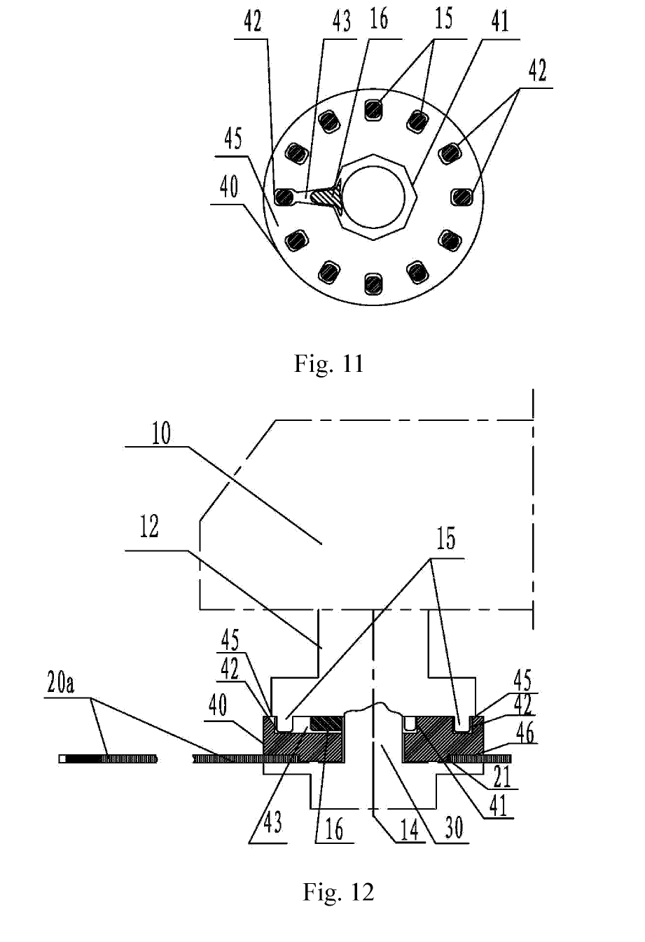

In FIG. 11, the first side 45 of the converter 40 is designed with an converter interface to connect the toggles on output shaft 12 of the pendulum tool. The converter interface has a converter center bore 41 and twelve hollowing-out areas 42 outside the converter, which can be inserted with twelve evenly distributed limited columns 15 in circumferential direction along the axis of output shaft 12 of the pendulum tool. The installation interface of converter 40 is set with a connecting segment 43 connected with the center bore 41 to connect the center bore 41 with at least one of the hollowing-out areas 42. The depressed portion between the center bore 41 and the connecting segment 43 can be inserted with the limited block 16 on output shaft 12 of the pendulum tool.

This type of the converter 40 can be assembled in twelve different angles onto the corresponding position of twelve evenly distributed limited columns 15 on the output shaft 12 of the pendulum tool. In the same way, it can be assembled in twelve different angles onto the following pendulum tools: pendulum tool with one, two, three, four, or six evenly distributed limited columns 15 on the corresponding position of its output shaft 12, including the ones that adopt the same way of even distribution of twelve columns 15 but several of the positions 15 are without limited columns 15; a pendulum tool with one limited block 16 on the corresponding position of the output shaft 12 in certain angle; a pendulum tool without any limit column 15 or limited block 16 on the corresponding position of the output shaft in any angle.

FIG. 13 shows the back view of the converter 40 in FIG. 11. A raised connecting segment of working head 47 is set on the second side of the converter 40 as the regular hexagon shown in the figure, to connect and fix the matching working head 20a. The connecting segment of working head can be of various shape and types as long as it can couple with the installation interface of the working head.

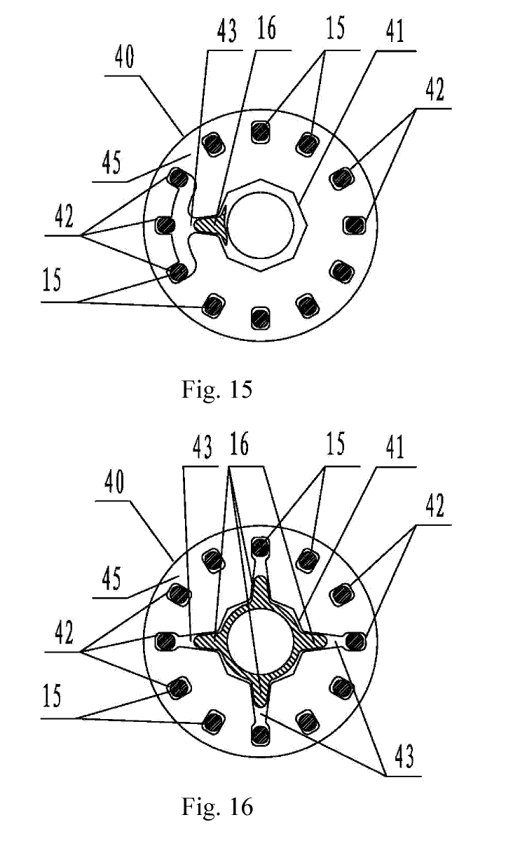

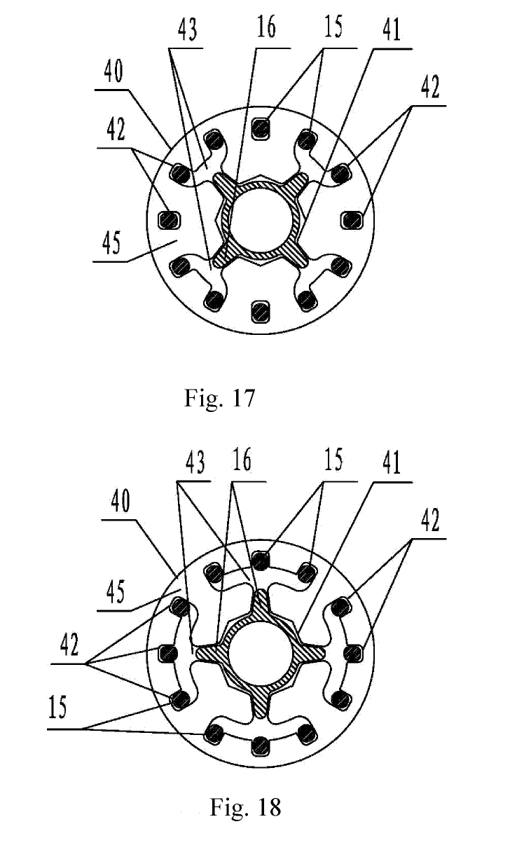

In FIGS. 14 and 15, the connecting segment 43 connected with the center bore 41 on installation interface of working head 40 is separately used to connect two or three neighboring hollowing-out areas 42. FIGS. 16, 17, 18, 19 and 20 show the converters of further improved embodiment.

In FIGS. 16, 17 and 18, the four evenly distributed connecting segment 43 on the installation interface of the converter 40 are connected with the center bore 41 to connect the center bore 41 with four, eight or twelve hollowing-out areas 42. The depressed surface between center bore 41 and connecting segment 43 can be inserted with four evenly distributed limited block 15 on the output shaft 12 of the pendulum tool. The number of isolated hollowing-out areas 42 of the converting center hold 41 is largely decreased, even eliminated. In this way, it improves the integrity and structural strength of the manufacturing mode of this type of working head.

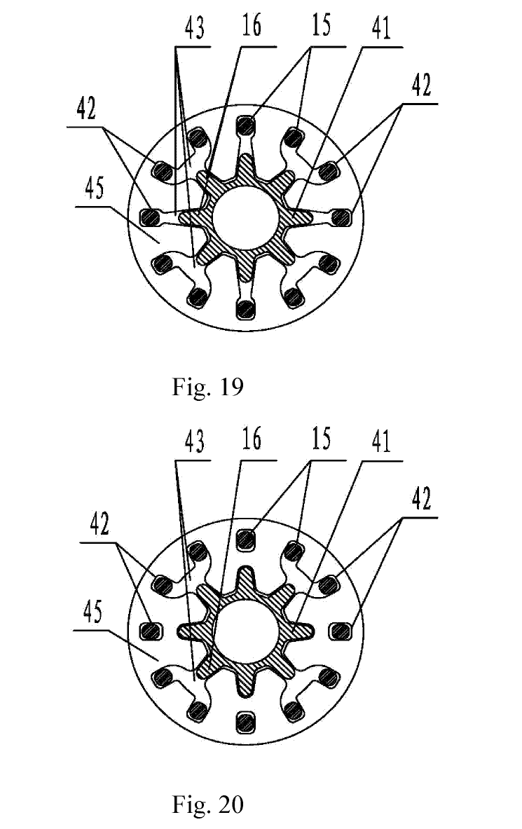

In FIGS. 19 and 20, eight evenly distributed connecting segments 43 connected with the center bore 41 on the installation interface of the converter 40 are disposed. It can be chose to connect four of the converters 43 with one corresponding neighboring hollowing-out areas 42; while the other four converters 43 are connected with the corresponding two neighboring hollowing-out areas 42. These two ways of connection are adopted alternatively. The depressed surface between center bore 41 and connecting segment 43 can be inserted with eight evenly distributed limited blocks 16 on the output shaft of the insertable pendulum tool. As shown in the figures, the module for manufacturing the converter is of relatively good integrity and structural strength, so as to produce relatively high structural strength of the converter. This type of converter can be assembled in eight defined angles onto the corresponding position of the output shaft on the pendulum tools, which have one, two, four or eight limited blocks or have positions for eight evenly distributed limited blocks with position of a plurality of limited blocks not being set. Without doubt, this type of converter can be assembled in twelve defined angles onto the corresponding position of the output shaft on the pendulum tool with twelve evenly distributed limit columns. This type of converter can be assembled in any angle onto output shaft of the pendulum tool without limited columns or limited blocks. The converter can be assembled in various angles onto pendulum tools for an easy operation and less work intensity.

In FIG. 21, the second side of the converter 40 is designed with three-teethed working head 20a with raised section with tooth 48, the tooth are higher than the coupling surface between converter 40 and working head 20a. When the converter 40 and operating 20a are fixed onto the output axis of the pendulum tool, a small part of the tooth section 48 will touch the working head 20a to partially insert into the working head 20a so as to reinforce the connecting strength. It has lower requirement on the shape of installation interface of working head 20a in a not-necessarily corresponding way. The normal working head can be fixed onto the output shaft of pendulum tool through the converter for an easy purchase and operation for operators.

The center bore of the interface on the converter can be circular, regular polygon, eight-star shaped, twelve-star shaped, etc.; the shape of converting segments of the interface is adapted to the cross section of the limited blocks on the output shaft of the pendulum tool. Limited blocks can be placed in the hollowing-out plane formed by the center bore and the converting segments, namely, the hollowing plane can hold the section of these limited blocks. The converting segments can be designed with or without the function as limiting with the limited blocks; the shape of the hollowing-out areas around the center bore is adapted to the shape of the limited column on the output shaft of the pendulum tool. Limited columns can be placed in the hollowing-out plane around the center bore, namely, the hollowing-out areas can hold the section of the limited columns. The converting segments can be designed with or without the function as limiting with the limited columns; the cross section of the limited column can be circular, elliptical, long circular or rectangular, so can the hollowing-out areas on the interface of the converter, accordingly. In addition, the hollowing-out areas of the converter can be partly intersected into the second side of the converter.

Self-evidently, the shape of the interface of the converter is flexible on the premise of the embodiments mentioned above. The professional technicians can decide the hollowing design on a plurality of parts of the interface of the convertor, which will not be repeated herein.

1. A working head of pendulum tool, its output shaft of the pendulum tool vibrates and drives around the axis and has fixing parts for fixing the working head, of which, the working head is equipped with an installation interface used for connecting with the fixing parts on the tool, the functional terminal of the working head can be sawing, grinding, cutting or polishing tools, as well as a functional terminal connecting with the interface which has a center bore and twelve hollowing-out areas around the center bore, it is characterized that at least one connecting segment pointing to the center bore in the installation interface of working head shall be disposed, enabling the center bore to connect with at least one hollowing-out area, the connecting segment is a groove or opening on the installation interface, the hollowing-out areas between which and the center bore can be the location of the limited blocks on the output shaft.

2. (canceled)

3. The working head of the pendulum tool of claim 1 is characterized in that the installation interface is equipped with at least four evenly distributed connecting segments which are linked with the center bore, while four evenly distributed limited blocks on the output shaft can be inserted in the hollowing plane formed due to the connection between the center bore and connecting segment.

4. The working head of the pendulum tool of claim 1 is characterized in that the installation interface is equipped with at least one connecting segment which is linked with the center bore is on the installation interface and the connecting segment is connected with two adjacent hollowing-out areas.

5. The working head of the pendulum tool of claim 1 is characterized in that the installation interface is equipped with at least one connecting segment which is linked with the center bore is on the installation interface and the connecting segment is connected with three adjacent hollowing-out areas.

6. The working head of the pendulum tool of claim 3 is characterized in that the installation interface is equipped with four evenly distributed connecting segments which are linked with the center bore and connected with adjacent hollowing-out areas one-for-one to make the communication between the center bore and the four hollowing-out areas, while the four evenly distributed limited blocks can be inserted in the hollowing plane formed due to the connection between the center bore and connecting segments.

7. The working head of the pendulum tool of claim 3 is characterized in that the installation interface is equipped with four evenly distributed connecting segments which are linked with the center bore and connected with adjacent hollowing-out areas one-for-two to make the communication between the center bore and the eight hollowing-out areas, while the four evenly distributed limited blocks can be inserted in the hollowing-out plane formed due to the connection between the center bore and connecting segment.

8. The working head of the pendulum tool of claim 3 is characterized in that the installation interface is equipped with four evenly distributed connecting segments which are linked with the center bore and connected with adjacent hollowing-out areas one-for-three to make the communication between the center bore and the twelve hollowing-out areas, while the four evenly distributed limited blocks can be inserted in the hollowing-out plane formed due to the connection between the center bore and connecting segment.

9. The working head of the pendulum tool of claim 3 is characterized in that the installation interface is equipped with eight evenly distributed connecting segments, among four of connecting segments, each connecting segment connects with one adjacent hollowing-out areas and among the rest every segment connect with two adjacent hollowing-out areas, these two connecting methods interlace with each other, while eight evenly distributed limited blocks on the output shaft can be placed in the hollowing-out plane formed by the center bore and the converting segments.

10. The working head of the pendulum tool of claim 3 is characterized in that the installation interface is equipped with eight evenly distributed connecting segments, among four of connecting segments each connecting segment connects with the center bore while not connects any hollowing-out area and among the rest four connecting segments every two segments connect with two adjacent hollowing-out areas, these two connecting methods interlace with each other, besides, eight evenly distributed limited blocks on the output shaft can be placed in the hollowing-out plane formed by the center bore and the converting segments.

11-20. (canceled)

21. The working head of the pendulum tool of claim 4 is characterized in that the installation interface is equipped with four evenly distributed connecting segments which are linked with the center bore and connected with adjacent hollowing-out areas one-for-two to make the communication between the center bore and the eight hollowing-out areas, while the four evenly distributed limited blocks can be inserted in the hollowing-out plane formed due to the connection between the center bore and connecting segment.

22. The working head of the pendulum tool of claim 5 is characterized in that the installation interface is equipped with four evenly distributed connecting segments which are linked with the center bore and connected with adjacent hollowing-out areas one-for-two to make the communication between the center bore and the eight hollowing-out areas, while the four evenly distributed limited blocks can be inserted in the hollowing-out plane formed due to the connection between the center bore and connecting segment.

23. The working head of the pendulum tool of claim 4 is characterized in that the installation interface is equipped with four evenly distributed connecting segments which are linked with the center bore and connected with adjacent hollowing-out areas one-for-three to make the communication between the center bore and the twelve hollowing-out areas, while the four evenly distributed limited blocks can be inserted in the hollowing-out plane formed due to the connection between the center bore and connecting segment.

24. The working head of the pendulum tool of claim 5 is characterized in that the installation interface is equipped with four evenly distributed connecting segments which are linked with the center bore and connected with adjacent hollowing-out areas one-for-three to make the communication between the center bore and the twelve hollowing-out areas, while the four evenly distributed limited blocks can be inserted in the hollowing-out plane formed due to the connection between the center bore and connecting segment.

25. The working head of the pendulum tool of claim 4 is characterized in that the installation interface is equipped with eight evenly distributed connecting segments, among four of connecting segments each connecting segment connects with one adjacent hollowing-out areas and among the rest every segment connect with two adjacent hollowing-out areas, these two connecting methods interlace with each other, while eight evenly distributed limited blocks on the output shaft can be placed in the hollowing-out plane formed by the center bore and the converting segments.

26. The working head of the pendulum tool of claim 5 is characterized in that the installation interface is equipped with eight evenly distributed connecting segments, among four of connecting segments each connecting segment connects with one adjacent hollowing-out areas and among the rest every segment connect with two adjacent hollowing-out areas, these two connecting methods interlace with each other, while eight evenly distributed limited blocks on the output shaft can be placed in the hollowing-out plane formed by the center bore and the converting segments.

27. The working head of the pendulum tool of claim 4 is characterized in that the installation interface is equipped with eight evenly distributed connecting segments, among four of connecting segments each connecting segment connects with the center bore while not connects any hollowing-out area and among the rest four connecting segments every two segments connect with two adjacent hollowing-out areas, these two connecting methods interlace with each other, besides, eight evenly distributed limited blocks on the output shaft can be placed in the hollowing-out plane formed by the center bore and the converting segments.

28. The working head of the pendulum tool of claim 5 is characterized in that the installation interface is equipped with eight evenly distributed connecting segments, among four of connecting segments each connecting segment connects with the center bore while not connects any hollowing-out area and among the rest four connecting segments every two segments connect with two adjacent hollowing-out areas, these two connecting methods interlace with each other, besides, eight evenly distributed limited blocks on the output shaft can be placed in the hollowing-out plane formed by the center bore and the converting segments.
